(19) United States
(12) Patent Application Publication
(10) Pub. No.: US 2014/0049487 A1
(43) Pub. Date: Feb. 20, 2014

(54) INTERACTIVE USER INTERFACE FOR CLOTHING DISPLAYS

(71) Applicant: QUALCOMM INCORPORATED, San Diego, CA (US)

(72) Inventors: Anne Katrin Konertz, San Diego, CA (US); Kevin Douglas Lee, San Diego, CA (US); Yinyin Liu, San Diego, CA (US)

(73) Assignee: QUALCOMM Incorporated, San Diego, CA (US)

(21) Appl. No.: 13/726,388

(22) Filed: Dec. 24, 2012

Related U.S. Application Data
(60) Provisional application No. 61/684,603, filed on Aug. 17, 2012.

(51) Int. Cl. G06F 3/041

(52) U.S. Cl. CPC G06F 3/041
USPC 345/173

(57) ABSTRACT

Techniques are disclosed for providing a user interface on a flexible display integrated on and/or into clothing. All or a portion of an article of clothing can function as a flexible display, enabling a user interface to be provided to a wearer of the article of clothing in a customized manner. The customized manner can be based on the type of information provided in the user interface and/or a triggering event invoking the user interface.

### CROSS-REFERENCE TO RELATED APPLICATION

This application claims to the benefit of U.S. Provisional Application No. 61/684,603, entitled “INTERACTIVE USER INTERFACE FOR CLOTHING DISPLAYS,” filed Aug. 17, 2012, which is assigned to the assignee hereof and expressly incorporated herein by reference.

### BACKGROUND

Personal electronic devices, such as mobile phones, tablet computers, portable media players, and the like, can execute a wide variety of software applications that enable users to perform a countless number of tasks. For example, a mobile phone can not only enable a user to make a telephone call, but can also enable the user to access the Internet and email, navigate a route with GPS-guided instructions, play video games, buy movie tickets, make reservations at a restaurant, create and share pictures and other content, and countless other functions. In fact, the functionality of personal electronic devices increases every day as more and more software applications become available for these devices. With this increased functionality, these personal electronic devices become an increasingly larger part of users' lives, requiring users to constantly dig through wallets or purses to find their personal electronic devices or keep the devices in their hands. Furthermore, due to their size, display capabilities of these personal electronic devices can be limited.

### SUMMARY

Embodiments of the present invention are directed toward providing a user interface on a flexible display integrated on and/or into clothing. Flexible display technologies can enable all or a portion of an article of clothing to function as a flexible display, which can provide a user interface to a user a customized manner. The customized manner can be based on the type of information provided in the user interface and/or a triggering event invoking the user interface.

An example apparatus, according to the disclosure, can include a flexible display disposed in or on an article of clothing, a memory, and a processor communicatively coupled to the flexible display and the memory. The processor is configured to cause the flexible display to imitate an appearance of the article of clothing when in an inactive state, determine a triggering event has occurred, and invoke a user interface on the flexible display. At least one of a size, shape, angle, or location of the user interface is based on the triggering event.

An example non-transitory computer-readable storage medium, according to the disclosure, has instructions embedded thereon for controlling a flexible display disposed in or on an article of clothing. The instructions include computer-executable code for causing the flexible display to imitate an appearance of the article of clothing when the flexible display is in an inactive state, determining a triggering event has occurred, and invoking a user interface on the flexible display. At least one of a size, shape, angle, or location of the user interface is based on the triggering event.

An example device, according to the disclosure, includes flexible display means disposed in or on an article of clothing, means for causing the flexible display means to imitate an appearance of the article of clothing when in an inactive state, means for determining a triggering event has occurred, and means for invoking a user interface on the flexible display means. At least one of a size, shape, angle, or location of the user interface is based on the triggering event.

A method for controlling a flexible display disposed in or on an article of clothing, according to the disclosure, can include causing the flexible display to imitate an appearance of the article of clothing when the flexible display is in an inactive state, determining a triggering event has occurred, and invoking a user interface on the flexible display. At least one of a size, shape, angle, or location of the user interface is based on the triggering event.

Items and/or techniques described herein may provide one or more of the following capabilities, as well as other capabilities not mentioned. Techniques can allow wearers to access information such as email, Internet, and other content without having to put on or carry other mobile electronic devices. Furthermore, clothing displays can be relatively large, allowing for easier and more ergonomic interaction with content. Moreover, the clothing displays can be integrated with sensors to invoke a user interface upon sensing certain triggering events, to make interaction with the clothing display fluid and natural. These and other embodiments, along with many of its advantages and features, are described in more detail in conjunction with the text below and attached figures.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIGS. 1A-1B are simplified drawings that illustrate the basic functionality of a clothing display, according to one embodiment.

FIGS. 2A-2C are simplified drawings that illustrate various user interfaces of a clothing display.

FIGS. 3A-3B show an embodiment of a user interface of a clothing display located on a sleeve of an article of clothing near the wearer's wrist, from the perspective of the wearer.

FIG. 4 is a flowchart illustrating an embodiment of a method for controlling a flexible display disposed in or on an article of clothing by utilizing techniques detailed herein.

FIG. 5 is a simplified block diagram of an embodiment of a computer system that can be utilized to perform at least a portion of some or all of the techniques provided herein.

### DETAILED DESCRIPTION

The following description is provided with reference to the drawings, where like reference numerals are used to refer to like elements throughout. While various details of one or more techniques are described herein, other techniques are also possible. In some instances, structures, and devices are shown in block diagram form in order to facilitate describing various techniques. Additionally, well-known elements of the invention will not be described in detail or will be omitted so as not to obscure the relevant details of the invention.

The terminology used herein is for the purpose of describing particular embodiments only and is not intended to be limiting of embodiments of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof

Embodiments of the present invention are directed toward providing a user interface on a flexible display integrated on and/or into clothing. Flexible display technology, such as certain active-matrix organic light-emitting diode (AMOLED) displays, can provide for displays with flexible properties similar to fabric, and can therefore be attached on or into an article of clothing without being bulky or uncomfortable. As another example, smart fibers capable of emitting and/or detecting light can enable the article of clothing itself or a portion thereof to function as a flexible display.

These and other forms of clothing displays can work with mobile phones, tablets, computers, personal media players, and other personal electronic devices (e.g., via a wireless connection) to impact the way in which a wearer receives information. Alternatively, clothing displays can replace these mobile electronic devices altogether by incorporating computing functionality into the clothing displays. In either case, this can allow wearers to access information such as email, Internet, and other content without having to put on or carry other mobile electronic devices. Furthermore, wearers of clothing displays can avoid problems that can arise when these mobile electronic devices are not immediately available, such as missing an incoming telephone call because a mobile phone was inside a purse, bag, or backpack. Furthermore, in contrast to other wearable displays, such as wristwatch displays, clothing displays can be relatively large, allowing for easier and more ergonomic interaction with content.

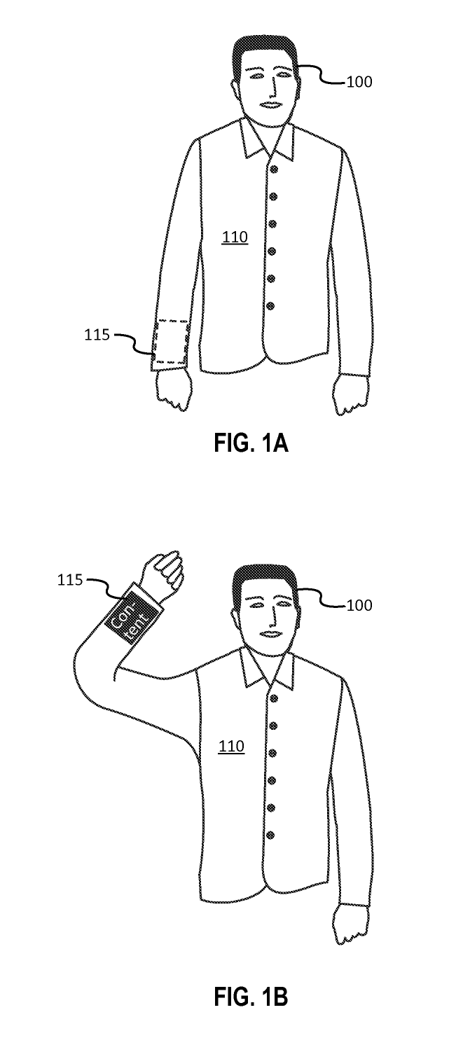

FIGS. 1A-1B are simplified drawings that illustrate the basic functionality of a clothing display, according to one embodiment. In this embodiment, the clothing display 115 is a portion of an article of clothing 110 that can display content to a wearer 100 when the clothing display 115 is in an active state. As discussed above, the clothing display 115 can be made from smart fibers that enable at least a portion of the clothing to have the properties of a flexible display. Additionally or alternatively, the clothing display 115 can be made from a flexible display that is attached to and/or embedded into the article of clothing 110. The clothing display 115 can have a computer embedded therein and/or can be communicatively coupled with a computer (e.g., wirelessly connected to a mobile phone, tablet, etc.) that can obtain and provide content for the clothing display 115. Furthermore, as discussed in more detail below, embodiments of the clothing display 115 can be localized to a relatively small area of an article of clothing such as the wrist or forearm, or may include a relatively large portion of the article of clothing. A person of ordinary skill in the art will recognize many substitutions, modifications, and alterations.

The clothing display 115 can be configured to be minimally visible, thereby being minimally intrusive to the wearer 100. FIG. 1A, for example, illustrates how the clothing display 115 can imitate the appearance of the rest of the article of clothing 110 when in an inactive state. The clothing display can do so in a variety of ways, depending on desired functionality. For example, in embodiments where the clothing display 115 is a transparent display disposed on the fabric of the article of clothing 110, the clothing display 115 can simply remove some or all content from the transparent display to allow the underlying fabric to be shown through the display. In other embodiments, the clothing display 115 may naturally mimic the fabric of the article of clothing 110 when in an inactive state (e.g., a display that turns black when turned off may mimic fabric of a black article of clothing), or may display content (e.g., an image) that imitates the fabric. In this latter example, the wearer 100 may be able to take and upload a picture of the fabric of the article of clothing 110 to the clothing display 115, which can be shown on the clothing display 115 when the clothing display is in an inactive state. This functionality can be useful, for removable clothing displays 115 that can be utilized with multiple articles of clothing. In some embodiments, the clothing display 115 or a portion thereof may show a pattern or design when in an inactive state, for example a striped pattern or a graphic design such as might appear on a t-shirt. The graphic or design may be pre-loaded when purchases and/or may be set by the user.

FIG. 1B, illustrates the clothing display 115 in an active state, displaying a user interface to the wearer 100. The clothing display 115 can be activated by any of a variety of triggering events, which can vary depending on desired functionality. For example, in embodiments in which the clothing display 115 is communicatively connected with a mobile phone, and/or has communicative features such as telephone features incorporated therein, a triggering event can include an incoming telephone call, Short Message Service (SMS, or “text”) message, a weather notification, a traffic notification, and/or the like. In embodiments in which the clothing display 115 has Internet connectivity, a triggering event can additionally or alternatively include an incoming email, Really Simple Syndication (RSS) feed, social network content update, and/or the like.

In one embodiment, a clothing display 115 can include one or more pictures of, for example, friends, family, and/or other social contacts in a social media network, which can be arranged and worn like an ornament on the article of clothing 110. The pictures shown on the can be linked to profiles of the social contacts such that, when a social contact changes and/or adds a picture to his or her profile, it triggers a corresponding change to the picture displayed on the clothing display 115.

Triggering events that activate the clothing display 115 can also involve sensor input. For example, the sensor input can include input from motion, heat, light, and/or other sensors. For example, motion sensors can be coupled with the clothing display 115 and/or the article of clothing 110 to allow the clothing display 115 to sense motions of the wearer 100. This can enable the clothing display 115 to switch from an inactive state to an active state when sensing a certain activating motion (e.g., when the wearer 100 raises his arm and looks at his wrist or performs an engagement gesture).

In some embodiments sensor input can also include sensors operable to sense health conditions of the wearer, such as sound sensors, heat sensors, motion sensors, and the like. In such embodiments, activation of the clothing display 115 can be triggered by certain detected conditions that may affect and/or be indicative of the wearer's health. These conditions can include detecting, for example, the wearer has fallen down, a change in the wearer's body temperature and/or pulse rate, and the like.

Other sensor input can come from user input devices communicatively coupled with the clothing display 115. These input devices can include a microphone, touch sensor, buttons, and/or the like, which can be utilized by the wearer 100 to provide input to the clothing display 115. Certain inputs can be used as triggering events to activate the clothing display 115. For example, a microphone can be used to allow voice activation of the clothing display 115, activating the clothing display 115 when the wearer 100 says a certain word or phrase. One or more touch sensors can be used to allow the user to interact directly with the clothing display 115 and/or content shown thereon. In some embodiments, the touch sensor(s) can be implemented coincident with the display, for example in a touchscreen. In other embodiments, the touch sensor is implemented separate from the display. For example, the user may touch a capacitive sensor on a palm of his glove (for example, by making a first) to activate a display on a sleeve of his shirt or jacket. The capacitive sensor may or may not have display functionality. The glove and jacket may be portions of a single article of clothing, or may be separate articles of clothing that are communicatively coupled. Thus, the inputs may be provided to a device or sensor that is separate from the article of clothing. As another example, the triggering event may comprise a motion made on a touchscreen of a phone or tablet communicatively coupled to the clothing. The motion may be compared to a known unlock motion associated with the user for security purposes.

Of course, sensor input need not be limited to triggering events, but may also be utilized in interaction with the clothing display once the clothing display is in an active state. For example, a wearer can reply to an SMS message with voice commands, speaking the reply, which can be interpreted through voice recognition hardware/software and displayed on the clothing display 115. When finished, the wearer can touch a “send” button, speak a predetermined “send” command, and/or provide some other input to send the message.

Embodiments of the clothing display 115 can also take into account wrinkles in the clothing display, depending on clothing display type, desired functionality, and/or other considerations. For example, a clothing display 115 comprising light-detecting smart fibers can detect the wearer's eyes and adapt the display accordingly, showing content to the wearer's eyes as if there were no wrinkles. Light, motion, pressure, orientation, and/or other sensors may be utilized to determine the position and/or angle at which the wearer is viewing the clothing display 115, as well as a state of the clothing display (e.g., where wrinkles may be located on the display). In some embodiments, an orientation of a user interface being displayed to the user may be adjusted based on the position and/or angle at which the wearer is viewing the clothing display 115. For example, the orientation of a user interface shown by the clothing display 115 shown in FIG. 1B may be continually adjusted as the wearer 100 raises his arm such that the user interface always appears upright to the wearer 100.

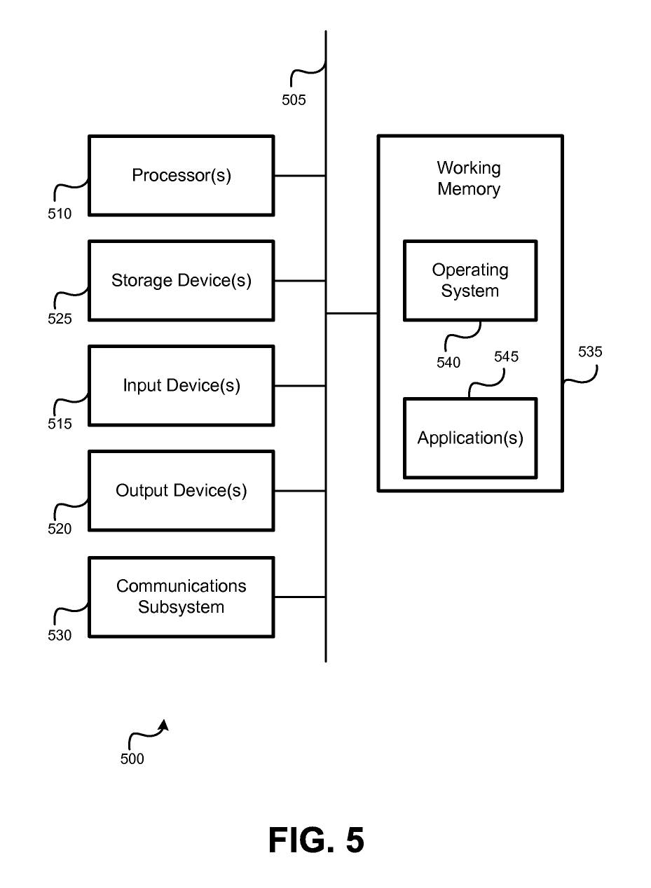

Another example of a triggering event may include information from a context awareness engine capable of determining a context of the user (e.g., exercising, shopping, driving, playing sports, watching a movie, etc.). For example, certain determined contexts and/or notifications from the context awareness engine may trigger an action or display. In one such embodiment, the context awareness engine may determine that the wearer 100 is in a meeting based at least in part on a calendar, location, and/or proximity to other devices of the user. When such context is determined, a processor may cause the clothing display 115 to show a user interface for taking notes or entering items into a to-do list. The context engine can be implemented via software and/or hardware components of a computer system, such as the computer system described in FIG. 5, that is communicatively coupled with and/or integrated into the clothing display 115.

In some embodiments, display of user content may be deferred until a user is authenticated. For example, when a triggering event is detected, a process for authenticating the user may be performed (or it may be determined that the user was previously authenticated and that the clothing has not been removed from the user, for example by touch and/or motion sensors). The process may include comparing biometric data of the wearer 100 to known biometric data of approved users or to biometric data of a user to which the user content is addressed. Thus, although several members of a family may wear a coat and receive messages at the coat, only the messages directed to the family member that is currently wearing the coat may be shown in some embodiments. In some embodiments, the wearer may be authenticated by performing a predetermined gesture or motion. This authentication may be performed at the user's convenience in some embodiments, or in response to each triggering event in some embodiments. For example, an audio tone, display, or other notification may alert the wearer that a triggering event has occurred and that the user may view the content upon authentication. In some embodiments, nothing is displayed before authentication. In other embodiments, a notice that the wearer is not authorized is displayed if the wearer has not been authenticated.

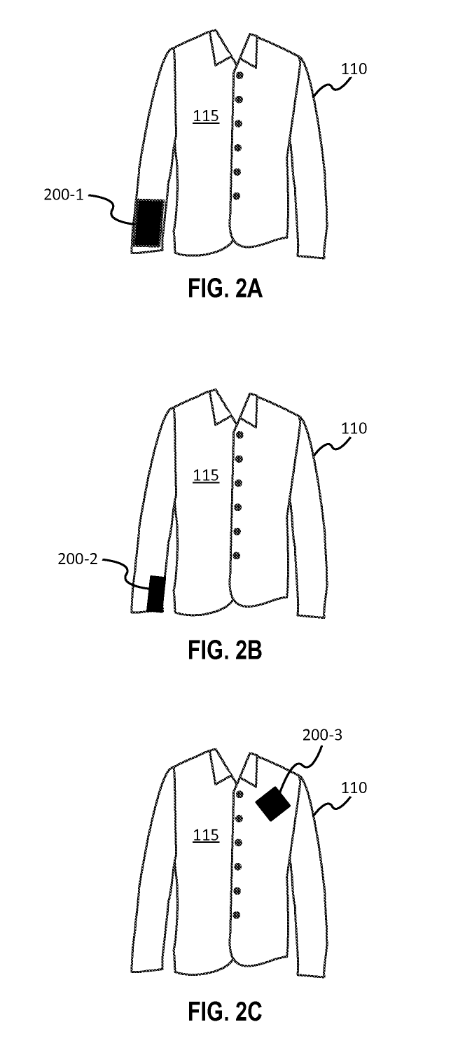

FIGS. 2A-2C are simplified drawings that illustrate how a user interface 200 of a clothing display 115 can vary, depending on the triggering event and/or other factors. In the embodiments illustrated in FIGS. 2A-2C, the clothing display 115 can cover a much larger portion of the article of clothing 110 than in the embodiment illustrated in FIGS. 1A-1B, such as the entire front surface, or even the entire surface of the article of clothing 110. In some embodiments, many smaller clothing displays 115 can be integrated into a single article of clothing 110 to provide functionality similar to a single, larger clothing display 115. Even so, the principles discussed in relation to FIGS. 2A-2C can also apply to smaller clothing displays 115.

The user interface's appearance, such as the size, angle, shape, location, and the like, can be based on factors such as a software application and/or privacy level associated with the user interface 200, user input, ergonomic considerations, and/or other factors. For example, FIG. 2A illustrates a clothing display 115 with a large user interface 200-1 shown on the forearm of the article of clothing 110. The relatively large size of the user interface 200-1 can be beneficial to display content of programs such as Internet browsers, RSS readers, and other software applications that display a large amount of content that may not be private to the wearer, such as news, media, advertisements, and the like.

In contrast, FIG. 2B illustrates a clothing display 115 with a relatively small user interface 200-2 on the wrist of the article of clothing 110. Because of its smaller size and discrete location, this user interface 200-2 can be associated with software applications such as SMS messaging, telephone calls, email, and/or the like, in which the wearer may want more privacy. Thus, for example, when a wearer 100 receives an incoming SMS message, the clothing display 115 can invoke the smaller user interface 200-2 to display the message, rather than the larger user interface 200-1.

FIG. 2C illustrates how a user interface 200-3 may be configured to be seen by people other than the wearer 100. This can be accomplished by causing the user interface 200-3 to be relatively large in size and/or locating the user interface 200-3 on lapel, chest, back, or other area of the article of clothing 110 that can be easily seen by others.

A high-visibility user interface 200-3 can be utilized in a variety of applications. For example, the user interface 200-3 can be used to show the wearer's support for a charity, progress toward a certain goal (e.g., weight loss, exercise, etc.), status in a game (e.g., “shot” in a game of laser tag), and/or the like. The content of the user interface 200-3 can be managed and updated by a related software application, (e.g., a social networking application for tracking exercise, a gaming application for tracking a player's status in laser tag, etc.), and/or by interaction by the wearer 100 (e.g., by pressing a touchscreen, button, or other user interface).

Appearance of the user interface 200 may default to one or more configurations, and/or may be set by the wearer 100. For example, when portions of the article of clothing 110 are configured as a touch screen, the wearer 100 may “drag” certain instances of the user interface 200 to another location and/or adjust the size of the user interface 200. Other embodiments may enable a wearer 100 to designate a customized appearance (location, size, etc.) in some other manner. In some embodiments, the content or application from which the user interface 200 is deriving information may be used to determine the location of the user interface 200. For example, work-related notifications may be shown on the left sleeve of the article of clothing 110, while personal notifications may be shown on the right sleeve. Depending on the desired functionality, the clothing display 115 may provide an application programming interface (API) that enables a software program (e.g., email application, Internet browser, RSS feed reader, etc.) to designate how the software program appears on the clothing display 115. Additionally or alternatively, these customizations may be made by an operating system communicatively coupled with and/or integrated into the clothing display 115.

A user interface 200 may also be activated and/or influenced by contextual data, which can indicate where the wearer is and/or what the wearer is doing. Some embodiments, for example, the clothing display 115 can receive input from a positioning device (e.g., Global Positioning System (GPS) receiver and/or other location device) to determine a location of the wearer 100. This may impact the appearance and/or content of a user interface 200. If the clothing display 115 determines that the wearer 100 has entered a movie theater, for example, the clothing display can enter an inactive state and/or reduce a brightness of the user interface 200. If the clothing display 115 determines that the wearer 100 has engaged in a certain activity (e.g., running), the clothing display 115 may limit content shown on the user interface 200 to display only the content that may be relevant to the wearer 100 during that activity (e.g., exercise tracking, clock, and music applications, etc.). In some embodiments, a processor may determine to hide certain information. For example, when a wearer is determined to be in a crowded room (for example using proximity data, Bluetooth information, contextual data derived from known events, etc.), the processor may cause the clothing display 115 to display content in a discreet location on the article of clothing 110, such as on a portion of the sleeve facing the wearer's torso or on an area that is covered by a flap or pocket, or to postpone display of the content until the wearer 100 is alone. In some embodiments, the content itself may be received with an indicator of a privacy level. Additionally or alternatively, a wearer 100 may be able to designate certain applications to have certain default privacy levels.

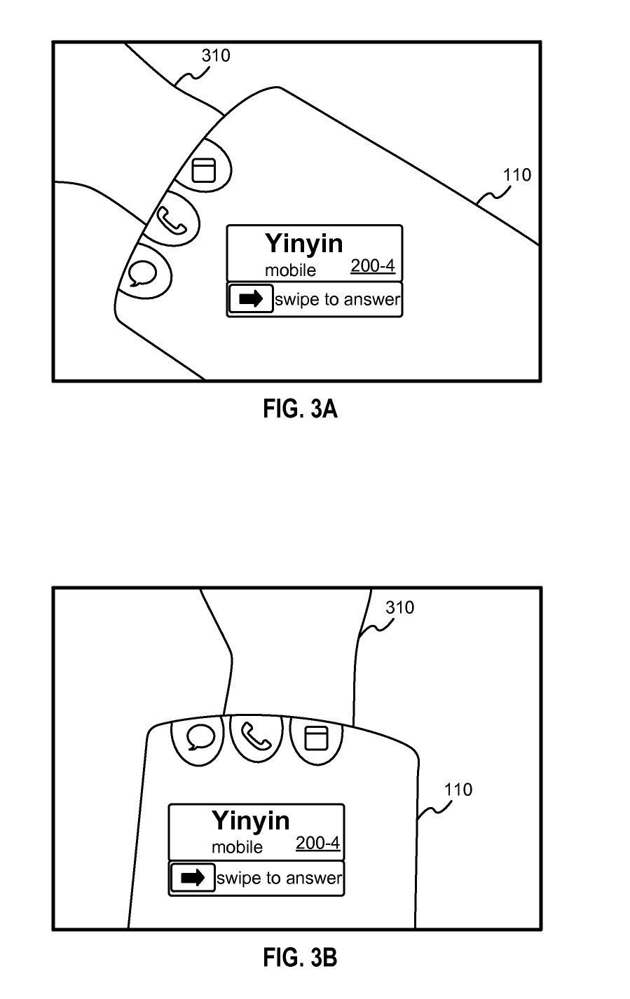

Depending on desired functionality, a wearer 100 can change the appearance of the user interface 200 of the clothing display 115 in a variety of ways. FIGS. 3A-3B help illustrate one example of how a wearer 100 can change the appearance of the user interface 200.

Although embodiments shown in the figures illustrate a clothing display 115 for an article of clothing worn on the wearer's upper body, a clothing display 115 can also be used in an article of clothing worn on the wearer's lower body, such as pants, a skirt, and the like. Some applications, such as sports, dance, or games, may include one or more clothing displays on one or more articles of clothing worn on both upper and lower body. Among other things, this can allow the clothing display(s) to provide a user interface virtually anywhere on the wearer's body. In a game of laser tag, for example, the clothing display(s) can indicate where a user is “shot.” In a sports application, where the clothing display(s) are communicatively coupled with motion sensors in the article(s) of clothing, it can provide feedback to a wearer, indicating that a certain motion was correct/incorrect, showing a part of the body to move, etc.

FIGS. 3A-3B show a user interface 200-4 located on a sleeve of an article of clothing 110 near the wearer's wrist 310, from the perspective of the wearer 100. In FIG. 3A, the user interface 200-4 includes content that is upright from the perspective of the wearer 100 when the wearer's wrist 310 is in an angled position. FIG. 3B illustrates how the content of the user interface 200-4 remains upright from the perspective of the user when the angle of the wearer's wrist 310 has changed. Thus, in this embodiment, the content shown on the user interface 200-4 can be rotated to accommodate any angle of the wearer's wrist 310, helping facilitate ergonomic viewing of the content. The angle of the user interface 200-4 in relation to the wearer's face can be determined using motion sensors such as gyroscopes, accelerometers, and the like, which can be embedded in the article of clothing 110 and/or communicatively coupled with the clothing display 115.

In embodiments utilizing a clothing display 115 with a touchscreen and/or other touch sensor(s), a wearer 100 can interact and/or change the appearance of the user interface 200 through interactive touch gestures. For example, as indicated above, a wearer 100 can change the location of the user interface 200 by “dragging” the user interface to the desired location. Similarly, the user can make gestures (e.g., outward pinching, inward pinching, rotating gestures, etc.) to alter the size, angle, shape, etc. of the user interface 200. Thus, a user interface 200 of the clothing display 115 can be customized by the wearer 100.

In one embodiment, the clothing display 115 allows the user to input data using gestures. In one embodiment, certain gestures correspond to certain commands. In another embodiment, the clothing display 115 shows characters or commands that the wearer 100 may select from, as well as some indication of where the wearer 100 is “pointing” at within that set of characters or commands. Thus, instead of pointing directly at an input, such as a user might do when commanding a television, the motions of the wearer 100 may be translated to the inputs shown on the clothing display 115. For example, in response to a wearer 100 extending his arm and moving his arm around, a display on a sleeve of the wearer's shirt may show a cursor moving around in a user interface. In another embodiment, a wearer 100 may point at a nearby object, or at a remote display, and a camera may be used to determine what the wearer 100 is pointing at. In one embodiment, wearers may play a game of virtual tag by pointing at each other or at displayed targets on each other's shirts. Thus, articles of clothing having flexible displays may communicate with each other in some embodiments.

The figures described above illustrate a clothing display 115 on an external portion of an article of clothing 110. The clothing display 115, however, may be attached to or integrated with an internal portion of the article of clothing 110 as well. For example, a clothing display 115 may be located on an inside portion of a sleeve such that the wearer may “roll” the cuff of the sleeve over to reveal the clothing display 115 or content being shown on a user interface 200 of the clothing display 115. In another embodiment, the clothing display 115 is integrated into an internal portion of the front of a shirt such that the wearer 100 may peer inside the shirt to view content.

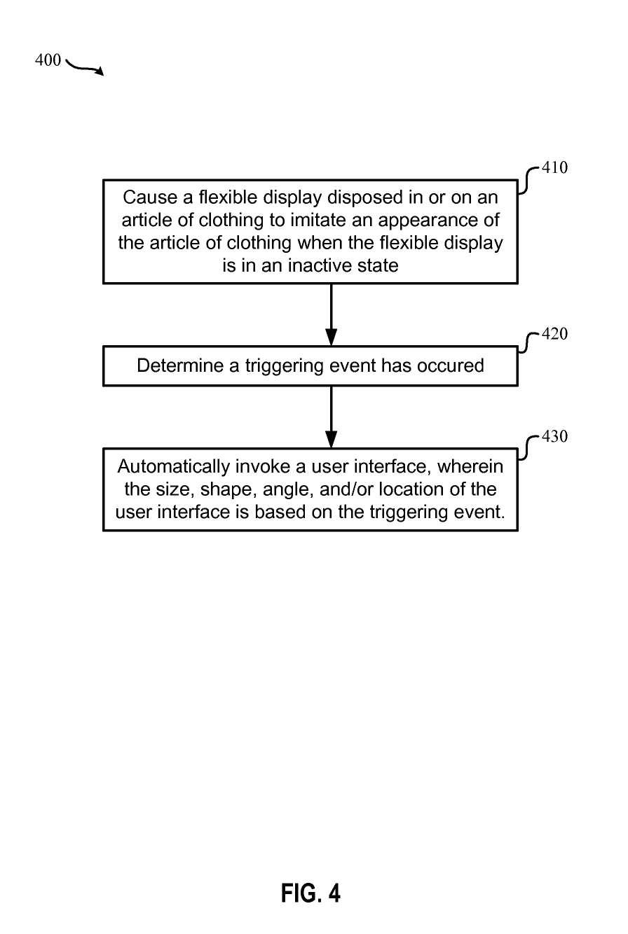

FIG. 4 is a flowchart illustrating an embodiment of a method 400 for controlling a flexible display disposed in or on an article of clothing by utilizing techniques detailed herein. The blocks detailed in FIG. 4 can be performed by one or more computer system(s), such as the computer system described in relation to FIG. 5 below, with a processor, memory, and/or similar means for performing the tasks shown in FIG. 4. Such computer system(s) could include, for example, a personal, tablet, and/or notebook computer, television, media player, smart phone, or other electronic device communicatively coupled with the flexible display (e.g., via a wireless interface), and/or a computer system integrated into the article of clothing and/or flexible display itself.

The method can start at block 410, where a flexible display disposed in or on an article of clothing is caused to imitate an appearance of the article of clothing when the flexible display is in an inactive state. As indicated previously, depending on the features of the flexible display and/or article of clothing, this can be implemented by removing elements on a transparent display to show underlying fabric of the article of clothing, turning off a display to mimic a texture and/or color of the article of clothing, and/or displaying an image that imitates or otherwise blends in with the fabric of the article of clothing so that the display is substantially indistinguishable from the article of clothing when in an inactive state. In embodiments in which the article of clothing itself is the flexible display (e.g., an article of clothing made from smart fibers), the flexible display can simply show an image or pattern that imitates an article of clothing. Such functionality helps enable the flexible display to “blend in” to a wearer's clothing in a subtle, nonintrusive manner.

At block 420 a triggering event is determined to have occurred. As discussed previously, the triggering event can be any of a variety of events, depending on desired functionality. Triggering events can include, for example, incoming messages and/or calls, and/or sensor input. Some embodiments may allow a wearer to customize which events trigger a user interface. For example, the wearer may customize a clothing display such that incoming text messages do not invoke a user interface, but incoming calls do.

Depending on desired functionality, sensor input may be utilized to make contextual determinations regarding the wearer. This may be taken into account when determining if an event triggers a user interface. For example, a certain motion may not be considered a triggering event if the wearer is determined to be driving a car, but may be considered a triggering event if the wearer is determined to be sitting at a desk. Contextual determinations can be determined using data from one or more sensor(s) communicatively coupled with the flexible display.

At block 430, a user interface is automatically invoked, where the size, shape, angle, and/or location of the user interface is based on the triggering event. In some embodiments, other aspects of the appearance additionally or alternatively may be based on the triggering event. As explained previously, triggering events can have associated software applications (e.g., telephone application, email client, Internet browser, etc.) and related privacy levels. Thus, an incoming text message may trigger a smaller, more discreet user interface than a gesture (e.g., the wearer raising his wrist) to invoke a user interface with no private content. Similar triggering events can be utilized to remove the user interface from the flexible display (e.g., put the flexible display in an inactive state). The user interface may comprise a mode for accepting an input to authenticate the wearer, or display of the user interface may be postponed until the wearer is authenticated in some embodiments.

It should be appreciated that the specific steps illustrated in FIG. 4 provide an example of a method 400 for controlling a flexible display disposed in or on an article of clothing. Alternative embodiments may include alterations to the embodiments shown. Furthermore, features may be added or removed depending on the particular applications. One of ordinary skill in the art would recognize many variations, modifications, and alternatives.

The term “user interface” as used herein can include an active portion of a clothing display in which content or images are displayed. The user interface may or may not allow user input or interaction, depending on the embodiment. For example, as shown in FIG. 3A, the user interface 200-4 may include “buttons” at the edge of the sleeve which the user may press or otherwise interact with. In contrast, a user interface 200 may comprise display of a picture, video, text, or other content which omits an input portion. In one embodiment, an SMS or MMS message may be displayed to a user for a short time after a triggering event regardless of actions being performed by the wearer.

As indicated above, just as certain triggering events can activate a user interface on the displays described herein, certain triggering events may also deactivate the user interface, or put the display in an inactive state. For example, the completion of certain events (e.g., sending a text message, finishing a telephone call, etc.) can cause the deactivation of a user interface. Moreover, detection that the user interface is not viewable by the wearer (e.g., above the wearer's head, behind the wearer's back, etc.) can also deactivate a user interface. Deactivation triggering events may also be time-based. For example, the failure of the wearer to interact with the user interface for a certain period of time (e.g., a “timeout”) may put the display in an inactive state.

Deliberate commands by a wearer can also be used to deactivate the user interface. For example, a certain voice command, which can be predetermined and/or configured in advance by the wearer (or other user), can deactivate a user interface. Touching a button on the user interface and/or providing similar input can also deactivate the user interface. Additionally or alternatively, for embodiments in which the display is configured to determine gesture input from a wearer, the wearer may make a predetermined deactivation gesture.

FIG. 5 illustrates an embodiment of a computer system 500, which may be incorporated into and/or communicatively coupled with a clothing display or other flexible, wearable display. One or more components of the computing system 500 could be shared between different devices, such as a flexible display, smart phone, tablet, personal computer, or other computing device. In some embodiments, software and other applications could be run on separate devices communicatively linked with each other. In other embodiments, a clothing display may have some or all of the computer system 500 integrated therewith.

FIG. 5 provides a schematic illustration of one embodiment of a computer system 500 that can perform the methods provided by various other embodiments. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements may include a processing unit, such as processor(s) 510, which can include without limitation one or more general-purpose processors, one or more special-purpose processors (such as digital signal processing chips, graphics acceleration processors, and/or the like), and/or other processing means, which can be utilized to perform at least a portion of the gesture recognition and/or image processing techniques described herein. Specifically, the processor(s) 510 and/or other components of the computer system 500 can be configured to perform the steps of the method 400 illustrated in FIG. 4. Hardware elements may also include one or more input devices 515, which can include without limitation one or more sensor(s), a microphone, touchscreen, positioning device, and/or the like. One or more output devices 520 are also included. These output devices can include one or more clothing displays and/or other display means, speakers, and/or other devices.

The computer system 500 may further include (and/or be in communication with) one or more non-transitory storage device(s) 525, which can comprise, without limitation, local and/or network accessible storage, and/or can include, without limitation, a disk drive, a drive array, an optical storage device, a solid-state storage device, such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The computer system 500 might also include a communications subsystem 530, which can include without limitation a modem, a network card (wireless or wired), an infrared communication device, a wireless communication device, and/or a chipset (such as a Bluetooth™ device, an 502.11 device, a WiFi device, a WiMax device, cellular communication facilities, etc.), and/or other receiving means. The communications subsystem 530 may permit data to be exchanged with a network, other computer systems, and/or any other devices (e.g. a clothing display) described herein. In many embodiments, the computer system 500 will further comprise a working memory 535, which can include a RAM or ROM device, as described above.

The computer system 500 also can comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 525 described above. In some cases, the storage medium might be incorporated within a computer system, such as computer system 500. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 500, and/or might take the form of source and/or installable code, which, upon compilation and/or installation on the computer system 500 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 500) to perform methods in accordance with various embodiments of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another computer-readable medium, such as one or more of the non-transitory storage device(s) 525. Merely by way of example, execution of the sequences of instructions contained in the working memory 535 might cause the processor(s) 510 to perform one or more procedures of the methods described herein. For example, the processor(s) 510 and/or other components of the computer system 500 can be configured to perform the steps of the method 400 illustrated in FIG. 4.

The terms “machine-readable medium” and “computer-readable medium,” as used herein, refer to any medium that participates in providing data that causes a machine to operate in a specific fashion. This can include non-transitory computer- and machine-readable storage media. In an embodiment implemented using the computer system 500, various computer-readable media might be involved in providing instructions/code to processor(s) 510 for execution and/or might be used to store and/or carry such instructions/code. In many implementations, a computer-readable storage medium is a physical and/or tangible storage medium. Such a medium may take the form of a non-volatile media or volatile media. Non-volatile media include, for example, optical and/or magnetic disks, such as the non-transitory storage device(s) 525. Volatile media include, without limitation, dynamic memory, such as the working memory 535.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500.

The communications subsystem 530 (and/or components thereof) generally will receive signals, and the bus 505 then might carry the signals (and/or the data, instructions, etc. carried by the signals) to the working memory 535, from which the processor(s) 510 retrieves and executes the instructions. The instructions received by the working memory 535 may optionally be stored on a non-transitory storage device 525 either before or after execution by the processor(s) 510.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Additionally, although embodiments disclose a clothing display with touch input (e.g., touchscreen), embodiments are not so limited. Various sensors coupled with a clothing display can provide input based on sound, visual input, movement of a wearer of the clothing display, movement of the clothing display, and the like. For example, a clothing display may receive input from detected pulling, swiping, twisting, rolling, etc. of the clothing display.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. An apparatus comprising:
a flexible display disposed in or on an article of clothing;
a memory; and
a processor communicatively coupled to the flexible display and the memory, the processor configured to:
cause the flexible display to imitate an appearance of the article of clothing when in an inactive state;
determine a triggering event has occurred; and
invoke a user interface on the flexible display, wherein at least one of a size, shape, angle, or location of the user interface is based on the triggering event.

2. The apparatus of claim 1, wherein the processor is configured to cause the flexible display to imitate the appearance of the article of clothing by:
becoming transparent, or
displaying an image that imitates the appearance of the article of clothing.

3. The apparatus of claim 1, wherein the triggering event includes at least one of:
an incoming message,
an update from a social media network,
an incoming RSS feed,
a weather notification,
a traffic notification,
an incoming telephone call, or
sensor input.

4. The apparatus of claim 3, wherein the sensor input includes data from at least one of:
a motion sensor,
a heat sensor,
a light sensor,
a microphone,
a touch sensor,
a positioning device, or
a sensor operable to sense a health condition of a wearer of the article of clothing.

5. The apparatus of claim 1, wherein the at least one of the size, shape, angle, or location of the user interface is also based on at least one of:
a software application,
a privacy level,
user input, or
ergonomic considerations.

6. The apparatus of claim 1, further comprising a wireless communications interface communicatively coupled to the processor.

7. The apparatus of claim 1, wherein the processor is configured to enable a wearer of the article of clothing to change an appearance of the user interface after the user interface is invoked.

8. The apparatus of claim 1, wherein the processor is configured to determine the triggering event based on contextual data related to a wearer of the article of clothing.

9. The apparatus of claim 8, further comprising at least one sensor communicatively coupled to the processor, wherein the contextual data is based on input from the at least one sensor.

10. A non-transitory computer-readable storage medium having instructions embedded thereon for controlling a flexible display disposed in or on an article of clothing, the instructions including computer-executable code for:
causing the flexible display to imitate an appearance of the article of clothing when the flexible display is in an inactive state;
determining a triggering event has occurred; and
invoking a user interface on the flexible display, wherein at least one of a size, shape, angle, or location of the user interface is based on the triggering event.

11. The computer-readable storage medium of claim 10, wherein the code for causing the flexible display to imitate the appearance of the article of clothing is configured to cause the flexible display to imitate the appearance of the article of clothing by:
becoming transparent, or
displaying an image that imitates the appearance of the article of clothing.

12. The computer-readable storage medium of claim 10, wherein the code for determining the triggering event has occurred includes code for detecting at least one of:
an incoming message,
an update from a social media network,
an incoming RSS feed,
a weather notification,
a traffic notification,
an incoming telephone call, or
sensor input.

13. The computer-readable storage medium of claim 12, wherein the sensor input includes data from at least one of:
a motion sensor,
a heat sensor,
a light sensor,
a microphone,
a touch sensor,
a positioning device, or
a sensor operable to sense a health condition of a wearer of the article of clothing.

14. The computer-readable storage medium of claim 10, wherein the code for showing the user interface on the flexible display is further configured to base the at least one of the size, shape, angle, or location of the user interface on at least one of:
a software application,
a privacy level,
user input, or
ergonomic considerations.

15. The computer-readable storage medium of claim 10, further including code for enabling a wearer of the article of clothing to change an appearance of the user interface after the user interface is invoked.

16. The computer-readable storage medium of claim 10, wherein the code for determining the triggering event includes code for basing the determination on contextual data related to a wearer of the article of clothing.

17. The computer-readable storage medium of claim 16, further including code for determining the contextual data based on input from at least one sensor.

18. A device comprising:
flexible display means disposed in or on an article of clothing;
means for causing the flexible display means to imitate an appearance of the article of clothing when in an inactive state;
means for determining a triggering event has occurred; and
means for invoking a user interface on the flexible display means, wherein at least one of a size, shape, angle, or location of the user interface is based on the triggering event.

19. The device of claim 18, wherein the means for causing the flexible display means to imitate the appearance of the article of clothing are configured to cause the flexible display means to imitate the appearance of the article of clothing by:
becoming transparent, or
displaying an image that imitates the appearance of the article of clothing.

20. The device of claim 18, wherein the means for determining the triggering event has occurred include means for detecting at least one of:
an incoming message,
an update from a social media network,
an incoming RSS feed,
a weather notification,
a traffic notification,
an incoming telephone call, or
sensor input.

21. The device of claim 20, wherein the sensor input includes data from at least one of:
a motion sensor,
a heat sensor,
a light sensor,
a microphone,
a touch sensor,
a positioning device, or
a sensor operable to sense a health condition of a wearer of the article of clothing.

22. The device of claim 18, wherein the means for invoking the user interface on the flexible display means are configured to base the at least one of the size, shape, angle, or location of the user interface on at least one of:
a software application,
a privacy level,
user input, or
ergonomic considerations.

23. The device of claim 18, further including means for enabling a wearer of the article of clothing to change an appearance of the user interface after the user interface is invoked.

24. The device of claim 18, wherein the means for determining the triggering event has occurred includes means for basing the determination on contextual data related to a wearer of the article of clothing.

25. The device of claim 24, further including means for determining the contextual data based on input from at least one sensor.

26. A method for controlling a flexible display disposed in or on an article of clothing, the method comprising:
causing the flexible display to imitate an appearance of the article of clothing when the flexible display is in an inactive state;
determining a triggering event has occurred; and
invoking a user interface on the flexible display, wherein at least one of a size, shape, angle, or location of the user interface is based on the triggering event.

27. The method of claim 26, further including causing the flexible display to imitate the appearance of the article of clothing by:
becoming transparent, or
displaying an image that imitates the appearance of the article of clothing.

28. The method of claim 26, wherein the triggering event includes at least one of:
an incoming message,
an update from a social media network,
an incoming RSS feed,
a weather notification,
a traffic notification,
an incoming telephone call, or
sensor input.

29. The method of claim 28, wherein the sensor input includes data from at least one of:
a motion sensor,
a heat sensor,
a light sensor,
a microphone,
a touch sensor,
a positioning device, or
a sensor operable to sense a health condition of a wearer of the article of clothing.

30. The method of claim 26, wherein at least one of the size, shape, angle, or location of the user interface is further based on at least one of:
a software application,
a privacy level,
user input, or
ergonomic considerations.

31. The method of claim 26, further including enabling a wearer of the article of clothing to change an appearance of the user interface after the user interface is invoked.

32. The method of claim 26, wherein determining the triggering event has occurred includes is based on contextual data related to a wearer of the article of clothing.

33. The method of claim 32, further wherein the contextual data is based on input from at least one sensor.
